(19) United States
(12) Patent Application Publication
(10) Pub. No.: US 2005/0244294 A1
(43) Pub. Date: Nov. 3, 2005

(54) Screw fluid machine

(75) Inventors: Kazuo Murakami, Kariya-shi (JP); Shinya Yamamoto, Kariya-shi (JP); Mamoru Kuwahara, Kariya-shi (JP); Rieko Harada, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki, Kariya-shi (JP)

(21) Appl. No.: 11/114,489

(22) Filed: Apr. 26, 2005

(30) Foreign Application Priority Data
Apr. 28, 2004 (JP) 2004-133289

(51) Int. Cl. F01C 1/16; F04C 18/00; F01C 1/24; F03C 4/00; F03C 2/00

(52) U.S. Cl. 418/201.1; 418/201.3

(57) ABSTRACT

A screw fluid machine includes a screw-shaped male rotor having formed helically therearound teeth and a screw-shaped female rotor having formed helically therearound grooves. The female rotor is engaged with the male rotor. A housing accommodates therein the male and female rotors. A working chamber is defined by the housing and the male and female rotors. Lead angles of the teeth and the grooves decrease from an inlet toward an outlet. An outline of each tooth includes a pair of first arc portions whose arc center is located on a pitch circle of the male rotor, and a second arc portion provided between the first arc portions. An outline of each groove includes a pair of third arc portions corresponding with the first arc portions, and a fourth arc portion substantially corresponding with the second arc portion.

### BACKGROUND OF THE INVENTION

The present invention relates generally to a screw fluid machine, more particularly to a screw fluid machine in which the lead angles of the teeth of a male rotor and the grooves of a female rotor decrease from an inlet toward an outlet.

Unexamined Japanese Patent Application Publication 10-311288 discloses a screw vacuum pump as an example of a screw fluid machine. As shown in FIG. 6, the screw vacuum pump of the above-cited reference includes a housing 61 and screw-shaped male and female rotors 62, 64 that are engaged with each other in the housing 61. The male rotor 62 has formed therearound helical teeth 63 whose outline is substantially arc-shaped as seen in the axial direction of the male rotor 62. The female rotor 64 has formed therearound helical grooves 65 which are complementary to the helical teeth 63 of the male rotor 62. The number of the grooves 65 of the female rotor 64 is larger than that of the teeth 63 of the male rotor 62 by one. Namely, the female rotor 64 has six grooves 65 while the male rotor 62 has five teeth 63. The male and female rotors 62, 64 and the housing 61 cooperate to form a working chamber 66. As the male and female rotors 62, 64 rotate, fluid such as air is drawn into the working chamber 66 through an inlet (not shown) which is formed at an end of the working chamber 66. The air sealed in the working chamber 66 is reduced in volume while it is transferred toward the other end of the working chamber 66. Then, the compressed air is discharged through an outlet (not shown) formed at the other end of the working chamber 66.

Meanwhile, the male and female rotors 62, 64 are formed such that the lead angle of screws (the teeth 63 and grooves 65) thereof decreases progressively from the inlet toward the outlet. Such screw vacuum pump is better than a screw vacuum pump with a constant lead angle of screw in terms of the degree of vacuum.

However, since the lead angle of the screw of the male and female rotors 62, 64 decrease from the inlet toward the outlet in the above conventional screw fluid machine, it is hard to machine accurately so as to form a groove in the part of a female rotor where the lead angle of the screw is relatively small. The groove has a substantially arc-shaped outline and is relatively narrow. Thus, machining for forming the groove in the female rotor at smaller lead angles is troublesome and hence time-consuming, which inevitably increases manufacturing cost. Therefore, there is a fear that the accuracy of the groove varies and the performance of the screw fluid machines fluctuates, accordingly.

The present invention is directed to a screw fluid machine of a type in which the teeth and grooves of the male and female rotors have decreasing lead angles, which facilitates the machining for forming of the groove in the female rotor and also improves the machining accuracy.

### SUMMARY OF THE INVENTION

According to the present invention, a screw fluid machine includes a screw-shaped male rotor having formed helically therearound teeth and a screw-shaped female rotor having formed helically therearound grooves. The female rotor is engaged with the male rotor. A housing accommodates therein the male and female rotors. A working chamber is defined by the housing and the male and female rotors. An inlet is formed adjacently to an end of the working chamber. An outlet is formed adjacently to another end of the working chamber. Lead angles of the teeth and the grooves decrease from the inlet toward the outlet. An outline of each tooth includes a pair of first arc portions whose arc center is located on a pitch circle of the male rotor and a second arc portion that is provided between the first arc portions. An outline of each groove includes a pair of third arc portions that correspond with the first arc portions and a fourth arc portion that substantially corresponds with the second arc portion.

### BRIEF DESCRIPTION OF THE DRAWINGS

The features of the present invention that are believed to be novel are set forth with particularity in the appended claims. The invention together with objects and advantages thereof, may best be understood by reference to the following description of the presently preferred embodiments together with the accompanying drawings in which:

FIG. 1 is a cross-sectional view of a screw vacuum pump of a first preferred embodiment according to the present invention;

FIG. 2 is an axial view of male and female rotors of the first preferred embodiment;

FIG. 3 is a partially enlarged axial view of the male and female rotors shown in FIG. 2 showing a tooth of the male rotor and a groove of the female rotor;

FIG. 4A is an axial view of male and female rotors of a second preferred embodiment according to the present invention;

FIG. 4B is a partially enlarged axial view of the male and female rotors shown in FIG. 4A showing a tooth of the male rotor and a groove of the female rotor;

FIG. 5A is an axial view of male and female rotors of a third preferred embodiment according to the present invention;

FIG. 5B is a partially enlarged axial view of the male and female rotors shown in FIG. 5A showing a tooth of the male rotor and a groove of the female rotor; and

FIG. 6 is an axial view of male and female rotors according to prior art.

### DETAILED DESCRIPTION OF THE PREFERRED EMBODIMENTS

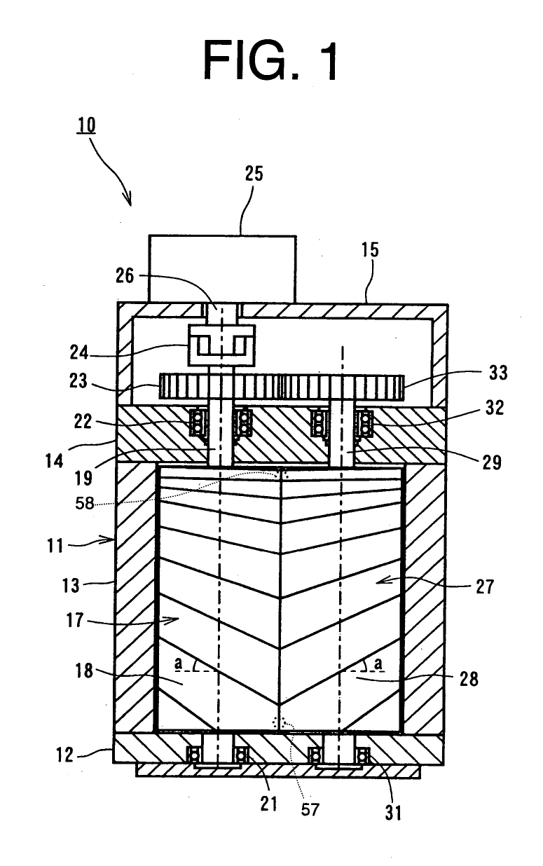

The following will describe a screw fluid machine of a first preferred embodiment according to the present invention with reference to FIGS. 1 through 3. FIG. 1 shows a screw vacuum pump 10 as an example of the screw fluid machine. The upper and lower sides of screw vacuum pump 10 as seen in FIG. 1 correspond to the rear and front sides thereof, respectively. The screw vacuum pump 10 will be referred to merely as vacuum pump hereinafter.

As shown in FIG. 1, the vacuum pump 10 of the present preferred embodiment has a pump housing 11 that includes a front housing 12, a rotor housing 13, a rear housing 14 and a gear housing 15. The front housing 12 is joined to the front end of the rotor housing 13, and the rear housing 14 is joined to the rear end of the rotor housing 13. The gear housing 15 is joined to the rear end of the rear housing 14. The pump housing 11 accommodates therein a screw-shaped male rotor 17 and a screw-shaped female rotor 27 that are engaged with each other. Working chambers 16 are defined by the male and female rotors 17, 27 and the pump housing 11.

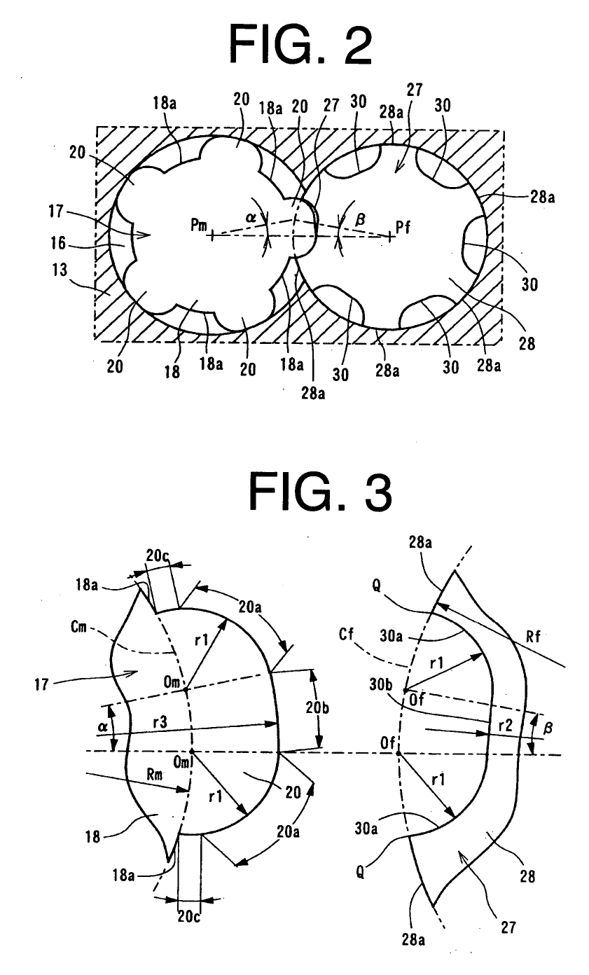

The male rotor 17 includes a rotor main body 18 and a rotary shaft 19 integrally connected to the rotor main body 18. The rotor main body 18 has formed therearound five teeth 20 that are arranged around the axis of the rotary shaft 19 at a regularly spaced interval as shown in FIG. 2. The rotor main body 18 has formed therearound and between any two adjacent teeth 20 a pitch arc portion (a fifth arc portion) 18a having the same radius as the pitch circle Cm of the male rotor 17 (FIG. 3). The teeth 20 of the male rotor 17 extend helically from the front end of the male rotor 17 toward the rear end, and the helical teeth 20 are formed such that the lead angle a thereof decreases from the front end of the male rotor 17 toward the rear end thereof in the helical direction of the teeth 20. As seen from FIG. 1, the teeth 20 circle around the rotor main body 18 at more than one turn. Thus, the number of turns of the teeth 20 is equal to or greater than one. As shown in FIG. 1, the rotary shaft 19 of the male rotor 17 is supported at its front end by the front housing 12 through a bearing 21 and at its rear end by the rear housing 14 through a bearing 22, respectively. The rotary shaft 19 of the male rotor 17 extends through the rear housing 14, and the rear end thereof is located in the gear housing 15. A gear 23 is connected to the rear end of the rotary shaft 19. A shaft coupling 24 is connected to the rear of the gear 23, and an output shaft 26 of a drive motor 25 fitted to the rear of the gear housing 15 is connected to the shaft coupling 24.

Like the male rotor 17, the female rotor 27 includes a rotor main body 28 and a rotary shaft 29 integrally connected to the rotor main body 28, as shown in FIG. 1. The rotor main body 28 has formed therearound six grooves 30 that are arranged around the axis of the rotary shaft 29 at a regularly spaced interval, as shown in FIG. 2. The rotor main body 28 has formed therearound and between any two adjacent grooves 30 a pitch arc portion (a sixth arc portion) 28a having the same radius as the pitch circle Cf of the female rotor 27. The grooves 30 extend helically from the front end of the female rotor 27 toward the rear end and are shaped complementary to the teeth 20 of the male rotor 17. The lead angle a of the grooves 30 decreases from the front end of the female rotor 27 toward the rear end thereof in the helical direction of the groove 30. The male and female rotors 17, 27 are arranged parallel to each other so that the teeth 20 of the male rotor 17 and the grooves 30 of the female rotor 27 are engaged with each other. As shown in FIG. 1, the grooves 30 circle around the rotor main body 28 at more than one turn. Thus, the number of turns of the grooves 30 is equal to or greater than one. The rotary shaft 29 of the female rotor 27 is supported at its front end by the front housing 12 through a bearing 31 and at its rear end by the rear housing 14 through a bearing 32, respectively. A gear 33 is connected to the rear end of the rotary shaft 29 in the gear housing 15 and engaged with the gear 23 on the rotary shaft 19 for the male rotor 17. Thus, with the operation of the drive motor 25, the male and female rotors 17, 27 rotate in opposite directions.

As shown in FIG. 1, an inlet 57 is formed in the rotor housing 13 adjacently to the front end of the working chamber 16. An outlet 58 is formed in the rotor housing 13 adjacently to the rear end of the working chamber 16. Compressible fluid such as air is drawn into the working chamber 16 from the inlet 57 under a pressure below the atmospheric pressure. With the male and female rotors 17, 27 rotating, the air is compressed in the working chamber 16 while being transferred to the rear end of the working chamber 16. The compressed air is discharged through the outlet 58.

The teeth 20 of the male rotor 17 and the grooves 30 of the female rotor 27 will be now described. First, the groove 30 of the female rotor 27 will be described. The outline of the female rotor 27 as seen in the axial direction thereof is shown in FIG. 1 and a portion that is recessed from the pitch circle Cf as shown in FIG. 3 corresponds to the groove 30. The outline of the groove 30 includes a pair of arc portions (third arc portions) 30a and a bottom arc portion (a fourth arc portion) 30b that connects the arc portions 30a. Arc centers Of of the respective arc portions 30a are located on the pitch circle Cf. The arc center of the bottom arc portion 30b coincides with a center Pf of the pitch circle Cf, and the outline of the groove 30 has substantially a wide U-shape. A radius r2 of the bottom arc portion 30b is determined by subtracting a radius r1 of the arc portions 30a from a radius Rf of the pitch circle Cf. An open angle β of the grooves 30 is an angle that is made between straight lines that respectively connect the arc centers Of of the arc portions 30a to the center Pf of the pitch circle Cf. For convenience of explanation, a point or a boundary that connects the pitch circle Cf and the groove 30 is referred to as top point Q.

The teeth 20 of the male rotor 17 will be now described. The outline of the male rotor 17 as seen in the axial direction is shown in FIG. 2. A part of the outline that protrudes outwardly from the pitch circle Cm as shown in FIG. 3 corresponds to the tooth 20. The outline of the tooth 20 includes a pair of arc portions (first arc portions) 20a and an outer diameter arc portion (a second arc portion) 20b that connects the arc portions 20a. Arc centers Om of the arc portions 20a are located on the pitch circle Cm. The arc center of the outer diameter arc portion 20b coincides with the center Pm of the pitch circle Cm of the male rotor 17, and a radius r1 of the arc portions 20a is the same as the radius r1 of the arc portions 30a of the female rotor 27. The arc portions 30a of the female rotor 27 correspond with the arc portions 20a of the male rotor 17 in a complementary manner, and the bottom arc portion 30b of the female rotor 27 substantially corresponds with the outer diameter arc portion 20b of the male rotor 17 in a complementary manner. The outline of each tooth 20 also includes a pair of curved portions 20c that are located between the arc portions 20a and the pitch circle Cm and correspond with the path that is traced by the top points Q. Thus, the outline of the tooth 20 substantially corresponds with that of the groove 30 of the female rotor 27 in a complementary manner.

An open angle a of the teeth 20 is an angle that is made between straight lines that respectively connect the arc centers Om of the arc portions 20a to the center Pm of the pitch circle Cm. In this preferred embodiment, the numbers of the teeth 20 of the male rotor 17 and of the grooves 30 of the female rotor 27 are respectively five and six as described above.

In such combination of the male and female rotors 17, 27, a ratio of the number of teeth 20 to the number of the grooves 30 is equal to that of the open angle β of the teeth 20 of the male rotor 17 to the open angle β of the grooves 30 of the female rotor 27, so that the teeth 20 and the grooves 30 are properly engaged with each other.

The male and female rotors 17, 27 are made of a suitable metal, and the grooves 30 of the female rotor 27 is formed by cutting with a machine tool such as an end mill. Since the groove 30 of the female rotor 27 has formed therein and between the paired arc portions 30a the bottom arc portion 30b, the width of the grooves 30 is made larger than heretofore relative to its depth. In forming the grooves 30 by cutting, a cutting tool can gain access easily to part of the female rotor 27 where the lead angle of the groove 30 is relatively small. Particularly, when the female rotor 27 is small in dimension, the widened grooves 30 by the provision of the bottom arc portion 30b between the paired arc portions 30a serve to facilitate the cutting of the portion of the female rotor 27 where the lead angle of the groove 30 is relatively small.

The following will describe the operation of the vacuum pump 10 of the present preferred embodiment. As the male rotor 17 is rotated by the drive motor 25 via the shaft coupling 24, the female rotor 27 is rotated in the opposite direction of the male rotor 17. With engagement of the tooth 20 of the male rotor 17 with the groove 30 of the female rotor 27 during the rotation of the male and female rotors 17, 27, air is drawn into the working chamber 16 through the inlet 57 under a pressure that is below the atmospheric pressure. The drawn air is reduced in volume with the rotation of the male and female rotors 17, 27. The compressed air forced out from the working chamber 16 is discharged out of the vacuum pump through the outlet 58.

According to the vacuum pump 10 of the present preferred embodiment, the following advantageous effects are obtained.

(1) Since the groove 30 has formed therein and between the paired arc portions 30a the bottom arc portion 30b, the width of the groove 30 of the female rotor 27 is made larger than heretofore relative to its depth. In forming the groove 30 by cutting, a cutting tool can gain access easily to part of the female rotor 27 where the lead angle of the groove 30 is relatively small. Thus, the cutting work is easily performed without using any advanced machining technique.

(2) Since cutting of the groove 30 by a cutting tool is made easy, the time for machining the female rotor 27 is shortened. In addition, the cutting accuracy for the groove 30 in the part of the female rotor 27 where the lead angle of the groove 30 is relatively small is improved, with the result that the operating performance of the vacuum pump 10 is improved.

(3) The provision of the bottom arc portion 30b between the paired arc portions 30a of the groove 30 helps prevent an excessive load from being applied to a cutting tool in cutting the groove 30. Thus, the rigidity of the cutting tool is retained, and the serviceable life thereof is extended.

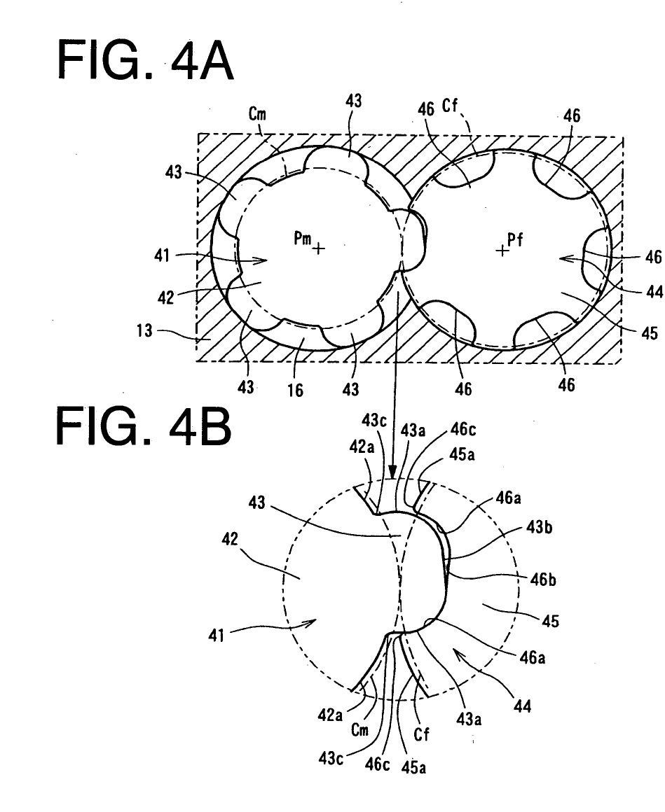

The following will describe the vacuum pump of a second preferred embodiment. FIG. 4A and 4B show the characterizing feature of the vacuum pump of the second preferred embodiment, namely a male rotor 41 and a female rotor 44. A rotor main body 42 of the male rotor 41 has formed therearound five teeth 43, whose outline includes a pair of arc portion (first arc portions) 43a and an outer diameter arc portion (a second arc portion) 43b. The rotor main body 42 has formed therearound and between any two adjacent teeth 43 a pitch arc portion (a fifth arc portion) 42a each having a radius that is smaller than that of the pitch circle Cm of the male rotor 41. The outline of the tooth 43 also includes a pair of curved portions 43c that curvedly connect the arc portions 43a and the pitch arc portions 42a. Meanwhile, a rotor main body 45 of the female rotor 44 has formed therearound six grooves 46 whose outline includes a pair of arc portions (third arc portions) 46a and a bottom arc portion (a fourth arc portion) 46b. The rotor main body 45 also has formed therearound and between any two adjacent grooves 46 a pitch arc portion (a sixth arc portion) 45a each having a radius that is larger than that of the pitch circle Cf of the female rotor 44. The rotor main body 45 has formed therearound curved portions 46c that curvedly connect the arc portions 46a of the groove 46 and the pitch arc portions 45a. The curved portion 43c substantially corresponds with the path (also called an envelope curve) that is traced by the curved portion 46c.

According to the vacuum pump of the present preferred embodiment, the work of cutting the groove 46 in the female rotor 44 is made easy. In addition, the curved portions 43c is provided to curvedly connect the pitch arc portion 42a of the male rotor 41 and the arc portion 43a, so that a sharp corner at the tooth root is eliminated and cutting of the tooth 43 in the male rotor 41 is made easy. Though not shown in the drawing, the ratio of the open angle of the teeth 43 of the male rotor 41 to the open angle of the grooves 46 of the female rotor 44 is equal to that of the number of the teeth 43 to the number of the grooves 46.

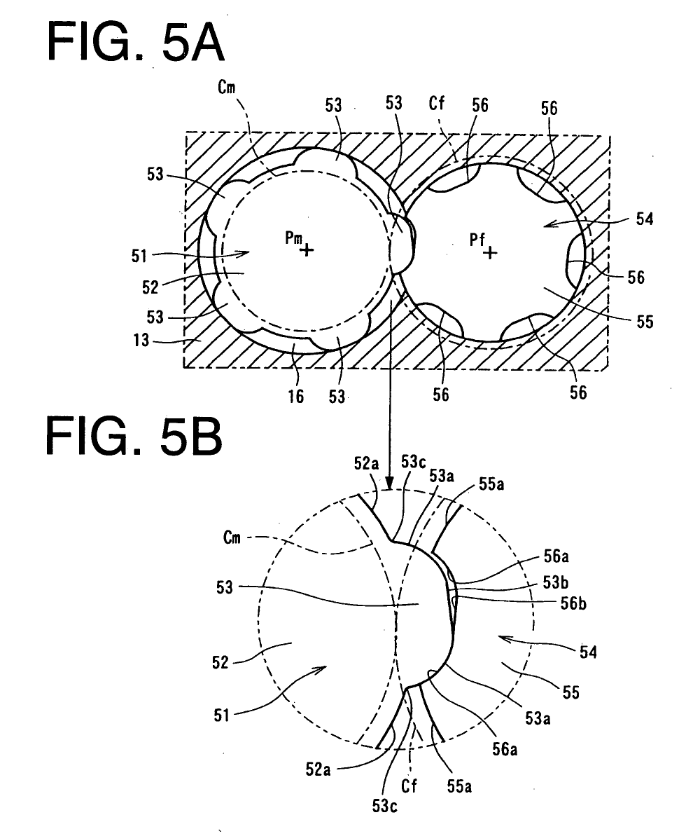

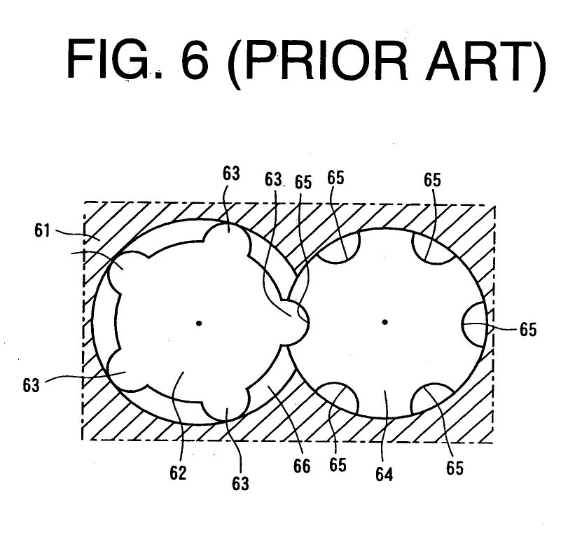

The following will describe the vacuum pump of a third preferred embodiment. FIG. 5A and 5B show the characterizing feature of the vacuum pump of the third preferred embodiment, namely a male rotor 51 and a female rotor 54. In the vacuum pump of the present preferred embodiment, a rotor main body 52 of the male rotor 51 has formed therearound five teeth 53 whose outline includes a pair of arc portion (first arc portions) 53a and an outer diameter arc portion (a second arc portion) 53b. The rotor main body 52 has formed therearound and between any two adjacent teeth 53 a pitch arc portion (a fifth arc portion) 52a each having a radius that is larger than that of the pitch circle Cm of the male rotor 51. The outline of the tooth 53 also includes a pair of curved portions 53c that curvedly connect the arc portions 53a and the pitch arc portions 52a of the male rotor 51. The curved portion 53c substantially corresponds with the path that is traced by a top point or a boundary between a pitch arc portion (a sixth arc portion) 55a and an arc portion 56a, which will be described later.

Meanwhile, a rotor main body 55 of the female rotor 54 has formed therearound six grooves 56 whose outline includes a pair of the arc portions (third arc portions) 56a and a bottom arc portion (a fourth arc portion) 56b. The rotor main body 55 has formed therearound and between any two adjacent grooves 56 the pitch arc portion 55a each having a radius that is smaller than that of the pitch circle Cf of the female rotor 54. The depth of the grooves 56 of the female rotor 54 is smaller than that of grooves 46 of the female rotor 44 of the second preferred embodiment.

According to the vacuum pump of the present preferred embodiment, cutting of the teeth 53 in the male rotor 51 is made easy. Since the grooves 56 of the female rotor 54 are shallow, the work of cutting the grooves 56 in the female rotor 54 is accomplished with ease. The ratio of the open angle of the teeth 53 of the male rotor 51 to the open angle of the grooves 56 of the female rotor 54 is equal to that of the number of the teeth 53 to the number the grooves 56.

The present invention is not limited to the above-described preferred embodiments, but may be modified into the following alternative embodiments.

In the above-described first, second and third preferred embodiments, the screw vacuum pump is described as an example of the screw fluid machine. It is noted, however, that the present invention is also applicable to a screw compressor.

In the above-described first, second and third preferred embodiments, the number of the teeth of the male rotor is five while the number of the grooves of the female rotor is six. Alternatively, the number of the teeth is four and the number of the grooves is six. As far as the number of the grooves is larger than that of the teeth, those numbers may be changed as required. The open angles of the teeth of the male rotor and of the grooves of the female rotor are determined in accordance with the numbers of the teeth and the grooves.

In the above-described first, second and third preferred embodiments, the number of the teeth of the male rotor is five while the number of the grooves of the female rotor is six. Alternatively, the number of the teeth is four and the number of the grooves is five. If the number of turns of the teeth and the groove is equal to or greater than one, the number of the groove may be larger than that of the teeth by one. The open angles of the teeth of the male rotor and of the grooves of the female rotor are determined in accordance with the numbers of the teeth and the grooves.

The present examples and embodiments are to be considered as illustrative and not restrictive, and the invention is not to be limited to the details given herein but may be modified within the scope of the appended claims.

1. A screw fluid machine comprising:
a screw-shaped male rotor having formed helically therearound teeth;
a screw-shaped female rotor having formed helically therearound grooves, the female rotor being engaged with the male rotor;
a housing accommodating therein the male and female rotors, a working chamber being defined by the housing and the male and female rotors;
an inlet formed adjacently to an end of the working chamber; and
an outlet formed adjacently to another end of the working chamber, lead angles of the teeth and the grooves decreasing from the inlet toward the outlet, wherein an outline of each tooth includes a pair of first arc portions whose arc center is located on a pitch circle of the male rotor and a second arc portion that is provided between the first arc portions, an outline of each groove including a pair of third arc portions that correspond with the first arc portions and a fourth arc portion that substantially corresponds with the second arc portion.

2. The screw fluid machine according to claim 1, wherein the number of the grooves of the female rotor is larger than that of the teeth of the male rotor, a ratio of an open angle of the teeth of the male rotor to an open angle of the grooves of the female rotor being equal to that of the number of the teeth to the number of the grooves.

3. The screw fluid machine according to claim 1, wherein an arc center of the second arc portion coincides with a center of the pitch circle of the male rotor, an arc center of the fourth arc portion coinciding with a center of a pitch circle of the female rotor.

4. The screw fluid machine according to claim 1, wherein the number of the grooves of the female rotor is larger than that of the teeth of the male rotor by one, a ratio of an open angle of the teeth of the male rotor to an open angle of the grooves of the female rotor being equal to that of the number of the teeth to the number of the grooves, the number of turns of the teeth and the grooves being equal to or greater than one.

5. The screw fluid machine according to claim 1, wherein the male rotor has formed therearound and between any two adjacent teeth a fifth arc portion, the female rotor having formed therearound and between any two adjacent grooves a sixth arc portion, each outline of the teeth including a pair of curved portions that connect the first arc portions and the fifth arc portions.

6. The screw fluid machine according to claim 5, wherein each of the curved portions corresponds with a path that is traced by a boundary between the sixth arc portion and the third arc portion of the female rotor.

7. The screw fluid machine according to claim 5, wherein a radius of the sixth arc portions of the female rotor is the same as that of a pitch circle of the female rotor, a radius of the fifth arc portions of the male rotor being the same as that of the pitch circle of the male rotor.

8. The screw fluid machine according to claim 5, wherein a radius of the sixth arc portions of the female rotor is larger than that of a pitch circle of the female rotor, a radius of the fifth arc portions of the male rotor being smaller than that of the pitch circle of the male rotor.

9. The screw fluid machine according to claim 5, wherein a radius of the sixth arc portions of the female rotor is smaller than that of a pitch circle of the female rotor, a radius of the fifth arc portions of the male rotor being larger than that of the pitch circle of the male rotor.

10. The screw fluid machine according to claim 1, wherein a radius of the first arc portions is the same as that of the third arc portions.

11. The screw fluid machine according to claim 1, wherein the screw fluid machine is a screw vacuum pump.
